(19) United States
(12) Patent Application Publication
(10) Pub. No.: US 2025/0383647 A1
(43) Pub. Date: Dec. 18, 2025

(54) CONTROL DEVICE, CONTROL SYSTEM, AND PROGRAM

(71) Applicant: FANUK CORPORATION, Minamitsuru-gun, Yamanashi (JP)

(72) Inventor: Takayoshi MATSUMOTO, Yamanashi (JP)

(21) Appl. No.: 18/875,362

(22) PCT Filed: Aug. 3, 2022
(86) PCT No.: PCT/JP2022/029815

§ 371 Date: Dec. 16, 2024

(51) Int. Cl. G05B 19/4061; B23Q 17/22; G05B 19/4069

(52) U.S. Cl. CPC G05B 19/4061; B23Q 17/2208; G05B 19/4069

(57) ABSTRACT

The present invention provides a control device, a control system, and a program that make it possible to prevent a tool etc. from causing interference when changing the direction of the tool with reference to an inclined surface. A control device according to an embodiment comprises a calculation unit, a selection unit, a control unit, and a determination unit. The calculation unit calculates a plurality of combinations of angles of a plurality of rotation shafts. The selection unit selects one combination from among the plurality of combinations. The control unit controls the plurality of rotation shafts and operates the plurality of rotation shafts such that the combination of angles thereof is the combination, in order to change the orientation of the tool, which is in a prescribed orientation. The determination unit determines one combination for use in actual operation from among the plurality of combinations.

### TECHNICAL FIELD

The present invention relates to a control device, a control system, and a program.

### BACKGROUND ART

In the case of machining shapes such as holes or pockets in an inclined surface of a workpiece using a machine tool, a program similar to the program used for the XY plane may be desired to be used for the machining.

Techniques for executing such machining include a technique for a numerical control device to define an inclined surface (tilted working plane indexing (G68.2)) and a technique to make the tool perpendicular to the inclined surface (tool axis direction control (G53.1)).

In the case of a machine tool with two rotational axes capable of changing the direction of the tool, there are two sets of angle combinations for the two rotational axes where the tool becomes perpendicular to the inclined surface. Conventional numerical control devices select the one with the smaller movement amount of the rotational axes from these two sats.

### CITATION LIST

### Patent Document

Patent Document 1: PCT International Publication No. WO2011/117915

### DISCLOSURE OF THE INVENTION

### Problems to be Solved by the Invention

However, with the angle combination selected by the numerical control device, interference may occur between the tool and other objects such as workpiece or jig.

A problem to be solved by embodiments of the present invention is to provide a control device, a control system, and a program, which are capable of preventing interference between the tool and other objects when changing the direction of the tool with reference to the inclined surface,

### Means for Solving the Problems

The control device of the embodiment includes a calculation unit, a selection unit, a control unit, and a determination unit. The calculation unit calculates a plurality of angle combinations for the plurality of rotational axes capable of changing the orientation of the tool, such that the tool forms a predetermined angle with a plane. The selection unit selects one combination from the plurality of angle combinations calculated by the calculation unit. The control unit controls the plurality of rotational axes to change the orientation of the tool oriented in a predetermined orientation such that the tool forms a predetermined angle with the plane, and operates the plurality of rotational axes such that the angle combination for the plurality of rotational axes becomes the combination selected by the selection unit. The determination unit determines one combination to be used for actual operation from the plurality of angle combinations calculated by the calculation unit.

### Effects of the Invention

The present invention is capable of preventing interference between the tool and other objects when changing the direction of the tool with reference to an inclined surface.

### BRIEF DESCRIPTION OF THE DRAWINGS

FIG. 1 is a block diagram illustrating an example of the main configuration of a numerical control system according to the first and second embodiments and components included in the numerical control system;

FIG. 2 is a flowchart illustrating an example of processing by the processor according to the first and second embodiments illustrated in FIG. 1;

FIG. 3 is a flowchart illustrating an example of processing by the processor according to the first embodiment illustrated in FIG. 1;

FIG. 4 is a flowchart illustrating an example of processing by the processor according to the first and second embodiments illustrated in FIG. 1;

FIG. 5 is a diagram illustrating a first example of the state of the tool and spindle when the tool is made perpendicular to the inclined surface of the workpiece;

FIG. 6 is a diagram illustrating a second example of the state of the tool and spindle when the tool is made perpendicular to the inclined surface of the workpiece; and

FIG. 7 is a flowchart illustrating an example of processing by the processor according to the second embodiment. illustrated in FIG. 1.

### PREFERRED MODE FOR CARRYING OUT THE INVENTION

Hereinafter, numerical control systems according to several embodiments will be described with reference to the drawings. In the drawings used in the following description of the embodiments, the scales of the respective parts may be appropriately modified. In the drawings used in the following description of the embodiments, configurations may be omitted for description purposes. In the drawings and this specification, the same reference numerals denote similar elements.

### First Embodiment

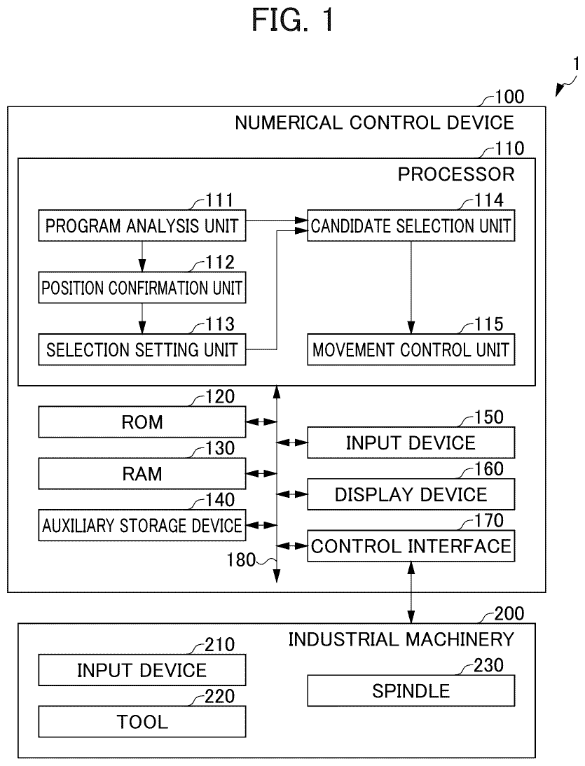

FIG. 1 is a block diagram illustrating an example of the main configuration of the numerical control system 1 according to the first embodiment and components included in the numerical control system 1. The numerical control system 1 includes, as an example, a numerical control device 100 and industrial machinery 200. The numerical control system 1 is an example of a control system.

The numerical control device 100 is a device that executes numerical control on the industrial machinery 200 or the like. The numerical control device 100 includes a function (hereinafter referred to as the “selection function”) to select and determine the angle combination that is considered optimal from among the candidate angle combinations for making the tool perpendicular to the inclined surface. The “angle combinations for making the tool perpendicular to the inclined surface” are hereinafter referred to as “angle combinations”. The numerical control device 100 may be a server device, PC, tablet terminal, or smartphone. The numerical control device 100 includes, as an example, a processor 110, a ROM (read-only memory) 120, a RAM (random-access memory) 130, an auxiliary storage device 140, an input device 150, a display device 160, and a control interface 170. These components are connected by a bus 180 or the like. The numerical control device 100 is an example of a control device. The perpendicularity of the tool to the inclined surface in this context is an example of a predetermined angle.

The processor 110 is the central part of the computer that executes the necessary computations and control for the operation of the numerical control device 100, executing various computations and processing. The processor 110 may be, for example, a CPU (central processing unit), MPU (micro processing unit), SoC (system on a chip), DSP (digital signal processor), GPU (graphics processing unit), ASIC (application specific integrated circuit), PLD (programmable logic device), or FPGA (field-programmable gate array). Alternatively, the processor 110 may be a combination of a plurality of these components. The processor 110 may also be combined with hardware accelerators. The processor 110 controls various functions of the numerical control device 100, based on programs such as firmware, system software, application software, and NC (numerical control) programs stored in the ROM 120 or the auxiliary storage device 140. The processor 110 executes the processing described later, based on these programs. Part or all of these programs may be embedded in the circuit of the processor 110. The NC program is a program for numerically controlling the industrial machinery 200.

By executing the above programs, the processor 110 functions as a program analysis unit 111, a position confirmation unit 112, a selection setting unit 113, a candidate selection unit 114, and a movement control unit 115.

The program analysis unit 111 analyzes the NC program.

The position confirmation unit 112 selects one set from the candidate angle combinations for the plurality of rotational axes. The position confirmation unit 112 causes the industrial machinery 200 to execute operations to make the tool perpendicular to the inclined surface. The position confirmation unit 112 executes re-confirmation.

The selection setting unit 113 determines the angle combination for the plurality of rotational axes to be used for actual operation.

The candidate selection unit 114 selects one set from the plurality of candidates.

The movement control unit 115 controls the rotational axes using the angle combination determined by the selection setting unit 113.

Details of the processing executed by the program analysis unit 111, the position confirmation unit 112, the selection setting unit 113, the candidate selection unit 114, and the movement control unit 115 will be described later.

The ROM 120 and the RAM 130 are the main storage devices of the computer centered around the processor 110. The ROM 120 is a non-volatile memory used exclusively for reading data. The ROM 120 stores firmware, for example, among the above programs. The ROM 120 also stores data used by the processor 110 for various processing. The RAM 130 is memory used for reading and writing data. The FAM 130 is used as a work area for temporarily storing data used by the processor 110 in executing various processing. The RAM 130 is typically volatile memory.

The auxiliary storage device 140 is an auxiliary storage device of the computer centered around the processor 110. The auxiliary storage device 140 may be, for example, EEPROM (electric erasable programmable read-only memory), HDD (hard disk drive), or flash memory. The auxiliary storage device 140 stores system software, application software, and NC programs, for example, among the above programs. The auxiliary storage device 140 stores data used by the processor 110 in executing various processing, data generated by processing in the processor 110, and various settings.

The input device 150 receives operations by the operator of the numerical control device 100. The input device 150 may be a keyboard, a keypad, a touchpad, a mouse, or a controller, for example. The input device 150 may also be a device for voice input.

The display device 160 displays screens to notify various information to the operator of the numerical control device 100. The display device 160 may be, for example, a liquid crystal display or an organic EL (electro-luminescence) display. A touch panel can also be used as the input device 150 and the display device 160. That is, the display panel included in the touch panel can be used as the display device 160, and the pointing device for touch input included in the touch panel can be used as the input device 150.

The control interface 170 is an interface for the numerical control device 100 to communicate with industrial machinery 200 or the like. The numerical control device 100 controls the industrial machinery 200 or the like through the control interface 170, based on the NC program.

The bus 180 includes a control bus, an address bus, and a data bus, and transmits signals exchanged among the various parts of the numerical control device 100.

The industrial machinery 200 is machinery that operates under numerical control or the like. The industrial machinery 200 may be, for example, a machine tool, a manipulator, a robot arm, or a robot. As an example, the industrial machinery 200 includes an input device 210, a tool 220, and a spindle 230.

The input device 210 receives operations by the operator of the industrial machinery 200. The input device 210 may be a control panel, a keyboard, a keypad, a touchpad, a touch panel, a mouse, or a controller, for example. The input device 210 may also be a device for voice input.

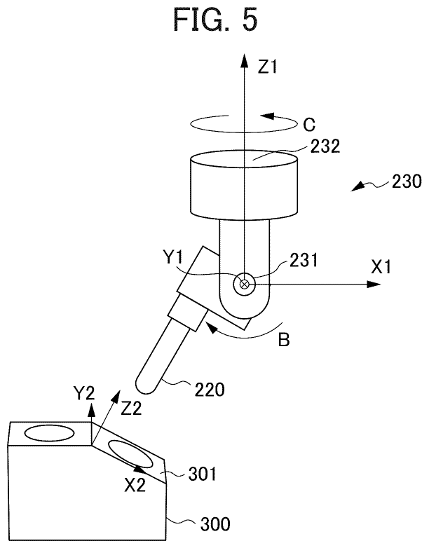

The tool 220 and the spindle 230 will be described with reference to FIG. 5. FIG. 5 is a diagram illustrating a first example of the state of the tool 220 and the spindle 230 when the tool 220 is made perpendicular to the inclined surface 301 of the workpiece 300.

The tool 220 is a tool such as a drill used for machining the workpiece 300.

The spindle 230 can attach the tool 220. The spindle 230 can rotate the tool 220 around the central axis of the tool 220, for example.

The spindle 230 includes a rotational axis 231 and a rotational axis 232. The rotational axis 231 can rotate in the B-axis direction. The spindle 230 can change the direction of the tool 220 by rotating the tool 220 in the B-axis direction around the rotational axis 231. The rotational axis 232 can rotate in the C-axis direction. The spindle 230 can change the direction of the tool 220 by rotating the tool 220 in the C-axis direction around the rotational axis 232. The rotational axes 231 and 232 are typically capable of rotating in both positive and negative directions. The rotational axes 231 and 232 may or may not be restricted in their range of rotation. The spindle 230 may include three or more rotational axes.

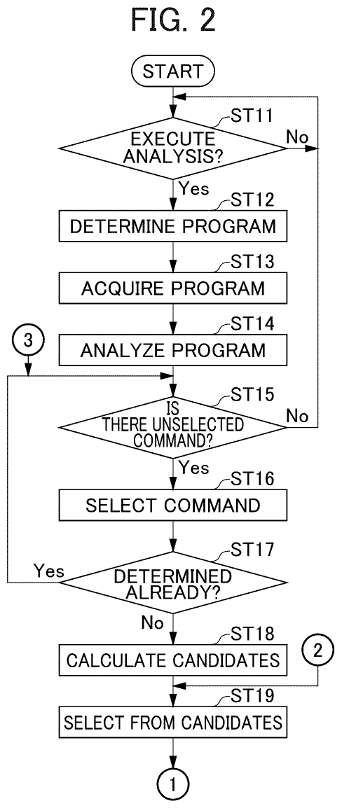

Hereinafter, the operation of the numerical control system 1 according to the first embodiment will be described with reference to FIGS. 2 to 4. The details of processing in the following operation descriptions are examples, and various processing that can achieve similar results can be appropriately used. FIGS. 2 to 4 are flowcharts illustrating examples of processing by the processor 110 of the numerical control device 100. The processor 110 executes the processing illustrated in FIGS. 2 to 4, based on programs stored in the ROM 120 or the auxiliary storage device 140, for example.

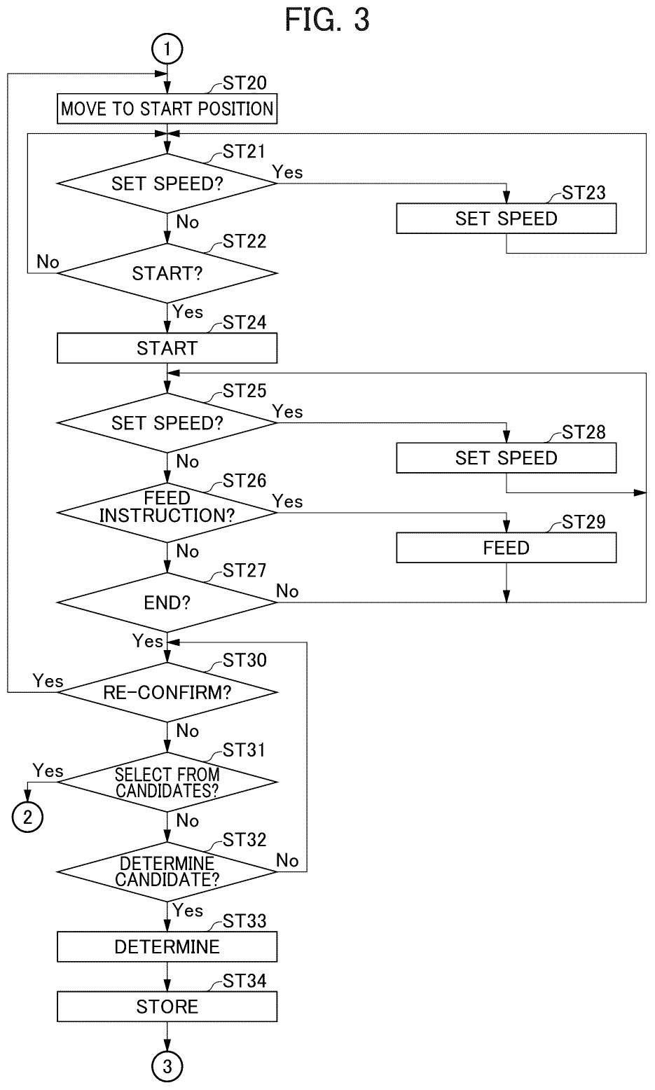

First, the operation of the numerical control device 100 in the case of executing the selection function will be described with reference to FIGS. 2 and 3. In Step ST11 of FIG. 2, the processor 110 of the numerical control device 100 determines whether to execute the selection function. For example, in a case where the input device 150 or the input device 210 is operated to input an instruction to execute the selection function, the processor 110 determines to execute the selection function. In a case where the input device 210 is operated, details of the operation are input to the numerical control device 100 via the control interface 170. Alternatively, in a case where a command instructing execution of the selection function is input from an external device or the like, the processor 110 determines to execute the selection function. The processor 110 may also determine to execute the selection function, based on a predetermined schedule. In the case of determining not to execute the selection function, the processor 110 determines “No” in Step ST11 and repeats the processing of Step ST11. Conversely, in the case of determining to execute the selection function, the processor 110 determines “Yes” in Step ST11 and proceeds to Step ST12.

In Step ST12, the processor 110 determines an NC program as a target to execute the selection function. The determined NC program is hereinafter referred to as the “target program”. The processor 110 determines the target program, based on the operation input to the input device 150 or the input device 210, for example. Alternatively, the processor 110 determines the target program, based on instructions from an external device or the like, for example. Alternatively, the processor 110 designates an NC program satisfying predetermined conditions as the target program. The predetermined conditions may include, for example, a condition that the NC program has not yet been designated as a target to execute the selection function. Alternatively, the predetermined conditions may include, for example, a condition that the setting of angle combinations in the selection function is incomplete.

In Step ST13, the processor 110 acquires the target program from the auxiliary storage device 140 or the like. The processor 110 may also acquire the target program from an external storage device.

In Step ST14, the processor 110 analyzes the target program. By analysis, the processor 110 checks whether the target program includes a vertical command. The vertical command is a command that makes the tool perpendicular to the inclined surface and sets a coordinate system based on the inclined surface. The inclined surface is defined by the vertical command. By analysis, the processor 110 checks the number of vertical commands in the target program. By analysis, the processor 110 obtains other information necessary for subsequent processing. For example, the program analysis unit 111 executes the processing of Step ST14.

In Step ST15, the processor 110 determines whether the target program includes an unselected vertical command. The vertical command is selected in Step ST16. Once selected, a vertical command no longer becomes unselected. In a case where the target program includes no vertical commands, the processor 110 determines that there are no unselected vertical commands. In the case of determining that the target program includes no unselected vertical commands, the processor 110 determines “No” in Step ST15 and returns to Step ST11. Conversely, in the case of determining that the target program includes unselected vertical commands, the processor 110 determines “Yes” in Step ST15 and proceeds to Step ST16.

In Step ST16, if there is a selected vertical command (hereinafter referred to as the “selected command”), the processor 110 cancels the selection of the vertical command. The processor 110 selects one from the unselected vertical commands in the target program. If there are a plurality of unselected vertical commands, the processor 110 prioritizes selecting the one to be executed first.

If the target program includes a plurality of vertical commands, two of them are referred to as the first vertical command and the second vertical command.

In Step ST17, the processor 110 determines whether the angle combination to be used for actual operation has been determined for the selected command. If the angle combination has been determined, the processor 110 determines “Yes” in Step ST17 and returns to Step ST15. Conversely, if the angle combination has not been determined, the processor 110 determines “No” in Step ST17 and proceeds to Step ST18. The determination on the angle combination will be described later.

Thus, by executing the processing of Step ST17, if one combination has already been determined by the determination unit, the processor 110 functions as an example of a control unit that does not operate the plurality of rotational axes such that the angle combination for the plurality of rotational axes becomes the combination selected by the selection unit.

In Step ST18, the processor 110 calculates the angle combination that makes the tool perpendicular to the inclined surface. The inclined surface is defined by the selected command. The angle combination calculated here is a candidate for the angle combination used in the actual control of the industrial machinery 200. If there are two rotational axes capable of changing the orientation of the tool 220, there are usually two candidates. However, depending on the range of rotation of each rotational axis, there may be fewer than two candidates. In a case where there are three or more rotational axes, the processor 110 may limit the calculated combinations to those satisfying predetermined conditions. The candidate combinations in the first vertical command are examples of the first combination. The candidate combinations in the second vertical command are examples of the second combination.

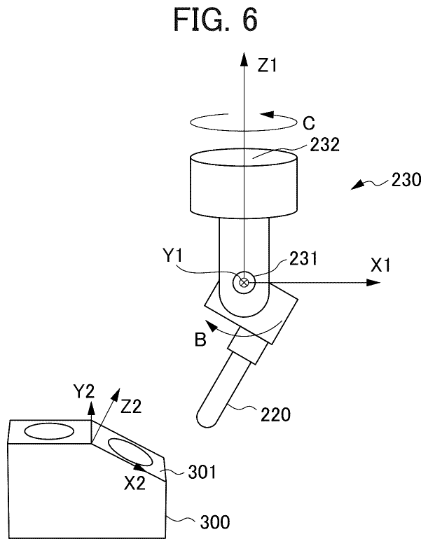

FIGS. 5 and 6 illustrate examples of two angle combination candidates. FIG. 6 is a diagram illustrating a second example of the state of the tool 220 and the spindle 230 when the tool 220 is made perpendicular to the inclined surface 301 of the workpiece 300.

The inclined surface 301 illustrated in FIGS. 5 and 6 is inclined by −30 degrees with respect to the X1 axis. The inclined surface 301 is parallel to the Y1 axis. The X1Y1Z1 coordinate system is the initial coordinate system before making the tool 220 perpendicular to the inclined surface. The X2Y2Z2 coordinate system is the coordinate system after making the tool 220 perpendicular to the inclined surface 301. That is, in the X2Y2Z2 coordinate system, the inclined surface 301 is parallel to the X2Y2 plane. Preferably, the inclined surface 301 coincides with the X2Y2 plane.

In the first example illustrated in FIG. 5, the angle of the rotational axis 231 is 30 degrees, and the angle of the rotational axis 232 is 0 degrees. In the second example illustrated in FIG. 6, the angle of the rotational axis 231 is −30 degrees, and the angle of the rotational axis 232 is 180 degrees.

Thus, by executing the processing of Step ST18, the processor 110 functions as an example of a calculation unit that calculates a plurality of angle combinations for the plurality of rotational axes capable of changing the orientation of the tool to form a predetermined angle with a plane.

In Step ST19, if there is a currently selected angle combination (hereinafter referred to as the “selected combination”), the processor 110 cancels the selection of the angle combination. Then, the processor 110 selects one combination from the angle combinations for the selected command. The processor 110 automatically selects one combination. In this case, the processor 110 randomly selects one combination, for example. Alternatively, the processor 110 may select one combination that satisfies predetermined conditions. The processor 110 may select the angle combination, for example, based on an operation input specifying the angle combination, rather than automatically. This operation input may be, for example, an input to the input device 150 of the numerical control device 100 or the input device 210 of the industrial machinery 200. Alternatively, the processor 110 may select the angle combination, based on an input specifying the angle combination from an external device or the like. The angle combination is calculated in Step ST18. After the processing of Step ST19, the processor 110 proceeds to the processing of Step ST20 in FIG. 3. For example, the candidate selection unit 114 executes the processing of Step ST19.

Thus, by executing the processing of Step ST19, the processor 110 functions as an example of a selection unit that selects one combination from the plurality of angle combinations calculated by the calculation unit.

In Step ST20 of FIG. 3, the processor 110 controls the industrial machinery 200 to move each part of the industrial machinery 200 to the position at the time of starting the selected command (hereinafter referred to as the “start position”). When the target program is executed up to immediately before the selected command, the position of each part of the industrial machinery 200 will be the start position of the selected command. For example, the processor 110 executes the target program up to immediately before the selected command in order to move each part of the industrial machinery 200 to the start position of the selected command. Alternatively, the processor 110 may move each part of the industrial machinery 200 to the start position without executing the target program.

For example, the processor 110 moves each part of the industrial machinery 200 to the start position by controlling and operating the real industrial machinery 200. Alternatively, the processor 110 may move each part of the industrial machinery 200 to the start position by controlling and operating a virtual industrial machinery 200. Operating the virtual industrial machinery 200 means operating the virtual industrial machinery 200 in a virtual space by simulation. For distinction, the real industrial machinery 200 is hereinafter referred to as industrial machinery 200A, and the virtual industrial machinery 200 is referred to as industrial machinery 200B. The rotational axes provided in the industrial machinery 200A are real rotational axes. The rotational axes provided in the industrial machinery 200B are virtual rotational axes.

When the processor 110 executes the target program up to immediately before the selected command, the position of each part of the industrial machinery 200 will be the start position of the selected command. The start position of the selected command will be described using the following NC program “00001” as an example.
N1 G54
N2 G90 G00 X200.0 Y200.0 Z300.0 B0 C90.0
N3 G68.2 P1 X50.0 Y0 2100.0 I0 J30.0 K0
N4 G53.1
N5 G43 H1 X0 Y0 Z0

In the NC program “00001”, the letter N followed by a number indicates the line number. For example, N3 indicates the third line. The NC program “00001” includes one vertical command.

The first line of the NC program “00001” is a command that determines the initial coordinate system, i.e., the X1Y1Z1 coordinate system.

The second line of the NC program “00001” is a command that moves the tool 220 of the industrial machinery 200.

The third line of the NC program “00001” is a command that defines the position and angle of the inclined surface 301 of the workpiece 300.

The fourth line of the NC program “00001” is the vertical command.

Therefore, in the NC program “00001”, the position after the tool 220 is moved by the command in the second line in the coordinate system set by the command in the first line is the start position of the vertical command in the fourth line. The orientation of the tool 220 at the start position is an example of a predetermined orientation. The orientation of the tool 220 at the start position of the first vertical command is an example of the first predetermined orientation. The orientation of the tool 220 at the start position of the second vertical command is an example of the second predetermined orientation.

In Step ST21, the processor 110 determines whether to set at least one of the movement speed or the movement method of the industrial machinery 200. If the input device 150 or the input device 210 is operated to input an instruction to set at least one of the movement speed or the movement method, the processor 110 determines to set at least one of the movement speed or the movement method. Alternatively, if there is an input of a command instructing to set at least one of the movement speed or the movement method from an external device or the like, the processor 110 determines to set at least one of the movement speed or the movement method. The processor 110 may automatically set at least one of the movement speed or the movement method. In this case, the processor 110 determines to set at least one of the movement speed or the. movement method only once. In the case of determining not to set at least one of the movement speed or the movement method, the processor 110 determines “No” in Step ST21 and proceeds to Step ST22.

In Step ST22, the processor 110 determines whether to start executing the selected command. If the input device 150 or the input device 210 is operated to input an instruction to Start executing the selected command, the processor 110 determines to start executing the selected command. Alternatively, if there is an input of a command instructing to start executing the selected command from an external device or the like, the processor 110 determines to start executing the selected command. In the case of determining not to start executing the selected command, the processor 110 determines “No” in Step ST22 and returns to Step ST21. Thus, the processor 110 remains in a standby state, repeating Steps ST21 and ST22 until determining to set at least one of the movement speed or the movement method of the industrial machinery 200 or until determining to start executing the selected command.

In the case of determining to set the movement speed of the industrial machinery 200 during the standby state of Steps ST21 and ST22, the processor 110 determines “Yes” in Step ST21 and proceeds to Step ST23.

In Step ST23, the processor 110 sets at least one of the movement, speed or the movement method of the industrial machinery 200. The target industrial machinery 200 may be the industrial machinery 200A or the industrial machinery 200B. The processor 110 sets, for example, at least one of the movement speed or the movement method, based on an operation input to instruct at least one of the movement speed or the movement method. This operation input may be an input to the input device 150 of the numerical control device 100 or the input device 210 of the industrial machinery 200. Alternatively, the processor 110 sets at least one of the movement speed or the movement method, based on an input from an external device instructing at least one of the movement speed or the movement method. Alternatively, the processor 110 may automatically set at least one of the movement speed or the movement method to a predetermined setting. The movement speed set here is preferably slower than the speed during normal operation. This aims to prevent the tool 220 from colliding with the workpiece or jig. This also aims to prevent damage in case of collision.

The movement methods for the industrial machinery 200 include normal movement methods in automatic operation and movement methods in manual operation. Types of manual operation include manual handle feed, jog feed, and incremental feed. Manual handle feed moves each part of the industrial machinery 200 in accordance with the speed at which the handle is turned while an operation indicating feed, such as turning the handle manually, is executed. Jog feed moves each part of the industrial machinery 200 at the set movement speed only while an operation indicating feed, such as pressing a switch manually, is turned on. Incremental feed moves each part of the industrial machinery 200 by a set amount at the set movement speed each time an operation indicating feed, such as pressing a switch manually, is executed. Handles and switches used for manual operation are included in the input device 210, for example. Alternatively, handles and switches used for manual operation may be included in the input device 150. After the processing of Step ST23, the processor 110 returns to Step ST21.

In the case of determining to start executing the selected command during the standby state of Steps ST21 and ST22, the processor 110 determines “Yes” in Step ST22 and proceeds to Step ST24. The processor 110 may automatically start executing the selected command. In this case, the processor 110 skips the processing of Step ST22 and proceeds to Step ST24.

In Step ST24, the processor 110 starts executing the selected command to which the selected combination is applied. By executing the selected command, the processor 110 controls the industrial machinery 200A or the industrial machinery 200B to move each part to set the angle combination for each rotational axis to the selected combination. In a case where the control target is the industrial machinery 2005, the selected command is executed as a simulation. In a case where the movement method is automatic operation, the processor 110 automatically moves each part by the processing of Step ST24. In a case where the movement method is manual operation, movement waits in a standby state until an operation indicating feed, such as a handle or switch, is executed. The selected command is started to be executed in Step ST24 to check the operation. That is, this operation is distinguished from the actual operation.

When executing the vertical command in the processing of Step ST24 and the processing of the actual operation, it is preferable for the processor 110 to operate the plurality of rotational axes of the industrial machinery 200 simultaneously rather than one by one. This is because the vertical command can be completed in a shorter time by simultaneously operating the plurality of rotational axes rather than operating the rotational axes one by one.

In a case where the control target is the industrial machinery 200B, the processor 110 controls the display device 160 to display the operation status of the industrial machinery 200B. The display device 160 displays the operation status of the industrial machinery 200B as 2D (two-dimensional) or 3D (three-dimensional) videos or the like.

The processor 110 functions as a display unit that displays the results of the simulation by displaying the operation status of the industrial machinery 200B in cooperation with the display device 160.

Thus, In a case where the movement method for the industrial machinery 200 is automatic operation, by executing the processing of Step ST24, the processor 110 functions as an example of a control unit that controls the plurality of rotational axes to change the orientation of the tool oriented in a predetermined orientation such that the tool forms a predetermined angle with the plane, and operates the plurality of rotational axes such that the angle combination for the plurality of rotational axes becomes the combination selected by the selection unit. The inclined surface 301 is an example of the plane. The inclined surface 301 in the first vertical command is an example of the first plane. The inclined surface 301 in the first vertical command is an example of the second plane.

In Step ST25, the processor 110 determines whether to set at least one of the movement speed or the movement method of the industrial machinery 200, in the same manner as in Step ST21. In the case of determining not to set at least one of the movement speed or the movement method, the processor 110 determines “No” in Step ST25 and proceeds to Step ST26.

In Step ST26, the processor 110 determines whether there is a feed instruction. If an operation indicating feed is executed, for example, the processor 110 determines that there is a feed instruction. If the movement method of the industrial machinery 200 is set to automatic operation, the processor 110 may skip the processing of Step ST26 and proceed to the processing of Step ST27. In the case of determining that there is no feed instruction, the processor 110 determines “No” in Step ST26 and proceeds to Step ST27.

In Step ST27, the processor 110 determines whether the execution of the selected command is complete. For example, if the angle combination for each rotational axis matches the selected combination, the processor 110 determines that the execution of the selected command is completed. In the case of determining that the execution of the selected command is not completed, the processor 110 determines “No” in Step ST27 and returns to Step ST25. Thus, the processor 110 remains in a standby state, repeating Steps ST25 to ST27 until determining to set at least one of the movement speed or the movement method of the industrial machinery 200, or until determining that there is a feed instruction, or determining that the execution of the selected command is completed.

In the case of determining to set at least one of the movement speed or the movement method of the industrial machinery 200 during the standby state of Steps ST25 to ST27, the processor 110 determines “Yes” in Step ST25 and proceeds to Step ST28.

In Step ST28, the processor 110 sets at least one of the movement speed or the movement method of the industrial machinery 200, in the same manner as in Step ST23. After the processing of Step ST28, the processor 110 returns to Step ST25.

In the case of determining that there is a feed instruction during the standby state of Steps ST25 to ST27, the processor 110 determines “Yes” in Step ST26 and proceeds to Step ST29.

In Step ST29, the processor 110 advances the execution of the selected command in accordance with the feed instructions. As a result, the industrial machinery 200 moves by the amount corresponding to the feed instructions.

In a case where the movement method of the industrial machinery 200 is set to manual handle feed, the industrial machinery 200 is moved at a speed corresponding to the speed at which the handle is turned. The industrial machinery 200 moves for a duration corresponding to the duration that the handle is turned.

In a case where the movement method of the industrial machinery 200 is jog feed, the processor 110 moves the industrial machinery 200 for a duration corresponding to the duration that the operation indicating the feed instruction has continued.

In a case where the movement method of the industrial machinery 200 is incremental feed, the processor 110 moves the industrial machinery 200 by an amount corresponding to the number of times the operation indicating the feed instruction is executed. After the processing of Step ST29, the processor 110 returns to Step ST25.

Thus, In a case where the movement method of the industrial machinery 200 is manual operation, by executing the processing of Steps ST24, ST26, and ST29, the processor 110 functions as an example of a control unit.

In the case of determining that the execution of the selected command is completed during the standby state of Steps ST25 to ST27, the processor 110 determines “Yes” in Step ST27 and proceeds to Step ST30.

In Step ST30, the processor 110 determines whether to execute re-confirmation. Re-confirmation refers to re-executing the selected command to which the selected combination is applied. If the input device 150 or the input device 210 is operated to input an instruction to execute re-confirmation, the processor 110 determines to execute re-confirmation. Alternatively, if there is an input of a command instructing re-confirmation from an external device or the like, the processor 110 determines to execute re-confirmation. In the case of determining not to execute re-confirmation, the processor 110 determines “No” in Step ST30 and proceeds to Step ST31. The processing of Step ST19 of FIG. 2 to Step ST30 of FIG. 3 is executed by, for example, the position confirmation unit 112.

In Step ST31, the processor 110 determines whether to select the angle combination. If the input device 150 or the input device 210 is operated to input an instruction to select the angle combination, for example, the processor 110 determines to select the angle combination. Alternatively, if there is an input of a command instructing the selection of the angle combination from an external device or the like, the processor 110 determines to select the angle combination. In the case of determining not to select the angle combination, the processor 110 determines “No” in Step ST31 and proceeds to Step ST32.

In Step ST32, the processor 110 determines whether to determine the angle combination to be used in the selected command. In the case of determining not to select the angle combination, the processor 110 determines “No” in Step ST32 and returns to Step ST30. Thus, the processor 110 remains in a standby state, repeating Steps ST30 to ST32 until determining to execute re-confirmation of the selected command to which the selected combination is applied, or until determining to select one of the angle combination candidates, or determine the angle combination.

In the case of determining to execute re-confirmation during the standby state of Steps ST30 to ST32, the processor 110 determines “Yes” in Step ST30 and returns to Step ST20.

In the case of determining to select one of the angle combination candidates during the standby state of Steps ST30 to ST32, the processor 110 determines “Yes” in Step ST31 and returns to Step ST19 of FIG. 2.

Then, upon returning to Step ST19, the processor 110 selects an angle combination different from the one whose selection was canceled in Step ST19, for example. Alternatively, the processor 110 selects an angle combination, based on an operation input specifying the angle combination. This operation input may be an input to the input device 150 of the numerical control device 100 or the input device 210 of the industrial machinery 200, for example. Alternatively, the processor 110 selects the angle combination, based on an input specifying the angle combination from an external device or the like.

Thus, the processor 110 executes the selected command to which each candidate angle combination is applied, while changing the selection of the angle combination for the selected command. By visually confirming the operation of the industrial machinery 200 to which each candidate angle combination is applied, the operator using the numerical control system 1 can confirm whether the tool 220 interferes with the workpiece 300 or jig, for example. Based on the confirmation results, the operator determines which angle combination to use in the actual operation. The operator specifies the angle combination to be used for the numerical control device 100 by operating the input device 150 or the input device 210.

In Step ST32 of FIG. 3, for example, the processor 110 determines to decide an angle combination when the input device 150 or the input device 210 is operated to input an instruction to specify which angle combination is used in the selected command. Alternatively, the processor 110 determines to decide an angle combination when there is an input specifying which angle combination is used in the selected command from an external device or the like. In the case of determining to decide the angle combination during the standby state of Steps ST30 to ST32, the processor 110 determines “Yes” in Step ST32 and proceeds to Step ST33.

In Step ST33, the processor 110 determines the angle combination to be used in the selected command for actual operation. The processor 110 determines the angle combination specified by the operation on the input device 150 or the input device 210 as the angle combination to be used in the selected command. Alternatively, the processor 110 determines the angle combination specified by an external device as the angle combination to be used in the selected command. The selection setting unit 113 executes the processing of Step ST33, for example.

Thus, by executing the processing of Step ST33, the processor 110 functions as an example of a determination unit that determines one combination to be used for actual operation from the plurality of angle combinations calculated by the calculation unit.

In Step ST34, the processor 110 stores the determination information in the auxiliary storage device 140 or the like, in association with the target program and the selected command. The determination information indicates the angle combination determined in Step ST33. After the processing of Step ST34, the processor 110 returns to Step ST15 in FIG. 2.

As described above, by repeating Step ST15 in FIG. 2 to Step ST34 in FIG. 3, the processor 110 determines the angle combination to be used for actual operation for each vertical command included in the target program and stores the angle combination in the auxiliary storage device 140 or the like.

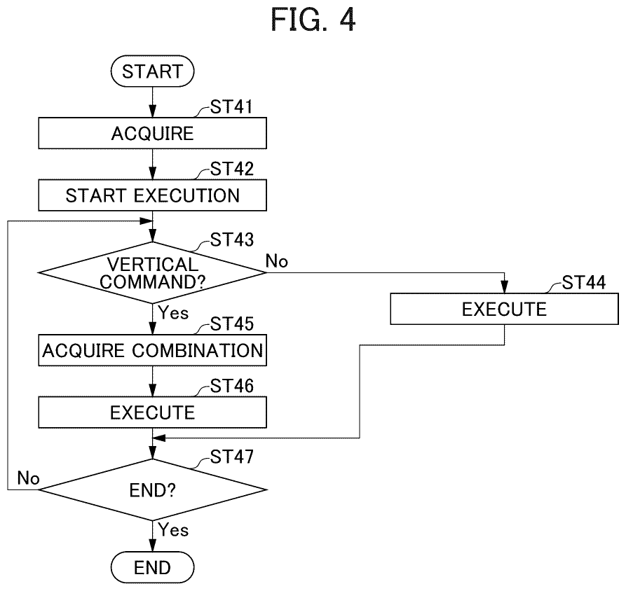

Next, the operation of the numerical control device 100 in the case of the actual operation of the industrial machinery 200 by actually using the NC program will be described with reference to FIG. 4.

In Step ST41 of FIG. 4, the processor 110 of the numerical control device 100 acquires the NC program to be executed from the auxiliary storage device 140 or the like. In a case where there is determination information associated with the NC program, the processor 110 also acquires the determination information.

In Step ST42, the processor 110 starts executing the acquired NC program.

In Step ST43, the processor 110 acquires the next command to be executed (hereinafter referred to as the “next command”) and determines whether the acquired next command is a vertical command. In the case of determining that the acquired next command is not a vertical command, the processor 110 determines “No” in Step ST43 and proceeds to Step ST44.

In Step ST44, the processor 110 executes the next command acquired in Step ST43.

Conversely, in the case of determining that the acquired next command is a vertical command, the processor 110 determines “Yes” in Step ST43 and proceeds to Step ST45.

In Step ST45, the processor 110 refers to the determination information associated with the vertical command and acquires the determined angle combination. The vertical command is the next command lastly acquired in Step ST43.

In Step ST46, the processor 110 executes the vertical command to which the angle combination acquired in Step ST45 is applied. The vertical command is the next command lastly acquired in Step ST43. The movement control unit 115 executes the processing of Step ST46, for example.

After the processing of Step ST44 or Step ST46, the processor 110 proceeds to Step ST47. In Step ST47, the processor 110 determines whether to end the execution of the acquired NC program. For example, if there is no next command, the processor 110 determines to end the execution of the NC program. In the case of determining not to end the execution of the NC program, the processor 110 determines “No” in Step ST47 and returns to Step ST43. Conversely, in the case of determining to end the execution of the NC program, the processor 110 determines “Yes” in Step ST47 and ends the processing of FIG. 4, ending the execution of the NC program.

According to the numerical control system 1 of the first embodiment, the numerical control device 100 selects one combination from the plurality of candidate angle combinations. By executing the vertical command to which the selected combination is applied, the numerical control device 100 controls and operates the industrial machinery 200. The industrial machinery 200 determines the angle combination to be used for actual operation.

As a result, the operator can confirm the operation status of the industrial machinery 200 for each candidate. Therefore, the operator can determine the candidate that is considered optimal from the plurality of candidates, as the angle combination to be used for actual operation. For example, from among each candidate, the operator can determine a candidate that does not cause interference, as the angle combination to be used for actual operation. In a case where there are a plurality of candidates that do not cause interference, from among each candidate that does not cause interference, the operator can determine the candidate with the shortest completion time, as the angle combination.

According to the numerical control system 1 of the first embodiment, the numerical control device 100 may control the real industrial machinery 200 in the selection function. In this case, the operator can confirm the operation status of the industrial machinery 200 by visually checking the real machine.

According to the numerical control system 1 of the first embodiment, the numerical control device 100 determines the angle combination to be used for actual operation, based on the operation input. Therefore, the operator can use his/her desired combination for the actual operation of the numerical control device 100.

According to the numerical control system 1 of the first embodiment, the numerical control device 100 may control the virtual industrial machinery 200 in the selection function. That is, the numerical control device 100 of the embodiment may execute simulation in the selection function. In this case, the numerical control device 100 of the embodiment does not need to operate the real industrial machinery 200. Therefore, the numerical control device 100 of the embodiment can execute the selection function even when the industrial machinery 200 is not available.

According to the numerical control system 1 of the first embodiment, the numerical control device 100 displays the simulation results. This allows the operator to confirm the operation status of the virtual industrial machinery 200.

According to the numerical control system 1 of the first embodiment, in a case where the NC program includes a plurality of vertical commands, the numerical control device 100 determines the angle combination to be used for actual operation for each vertical command. As a result, even in a case where the NC program includes a plurality of vertical commands, the operator can use his/her desired combination for actual operation of the numerical control device 100 for each vertical command.

According to the numerical control system 1 of the first embodiment, the numerical control device 100 skips the processing of determining the combination for vertical commands, for which the angle combination to be used for actual operation has already been determined. As a result, the numerical control device 100 of the embodiment can prevent the operator from unnecessarily re-confirming the operation of the vertical commands, for which the angle combination to be used for actual operation has already been determined.

### Second Embodiment

In the second embodiment, the numerical control device 100 automatically determines the angle combination to be used in the selected command. The configuration of the numerical control system 1 in the second embodiment is similar to that in the first embodiment.

Hereinafter, the operation of the numerical control system 1 according to the second embodiment will be described with reference to FIGS. 2, 4, and 7. The details of processing in the following operation descriptions are examples, and various processing that can achieve similar results can be appropriately used. FIGS. 2, 4, and 7 are flowcharts illustrating examples of processing by the processor 110 of the numerical control device 100. The processor 110 executes the processing illustrated in FIGS. 2, 4, and 7, based on programs stored in the ROM 120 or the auxiliary storage device 140, for example.

In the description of the operation of the second embodiment, parts that are the same as in the first embodiment may be omitted.

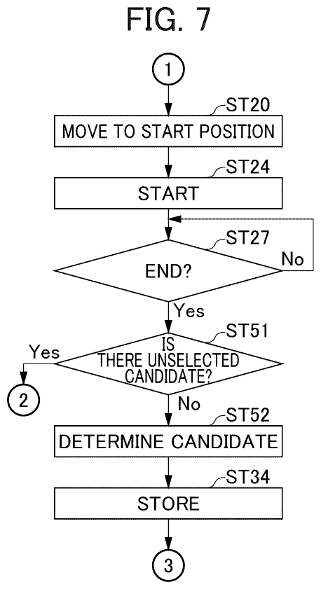

In the second embodiment, the processor 110 executes the processing illustrated in FIGS. 2 and 4, as in the first embodiment. In the second embodiment, the processor 110 executes the processing illustrated in FIG. 7 instead of FIG. 3.

In the second embodiment, in Step ST20 of FIG. 7, the processor 110 controls the industrial machinery 200B to move each part of the industrial machinery 200B to the start position.

In the second embodiment, after the processing of Step ST20, the processor 110 proceeds to Step ST24.

In the second embodiment, in Step ST24, the processor 110 treats the industrial machinery 200B as the control target. That is, in the second embodiment, the execution of the selected command, to which the selected combination is applied, is limited to simulation. In the second embodiment, the movement method of the industrial machinery 200B is automatic operation. In the second embodiment, it is preferable for the processor 110 to execute the simulation at a speed corresponding to the processing speed of the processor 110 without considering the setting of the movement speed. Therefore, the processor 110 does not need to set the movement speed.

In the second embodiment, after the processing of Step ST24, the processor 110 proceeds to Step ST27.

In the second embodiment, in the case of determining “No” in Step ST27, the processor 110 returns to Step ST27. In the case of determining “Yes” in Step ST27, the processor 110 proceeds to Step ST51.

In Step ST51, the processor 110 determines whether there is an unselected angle combination. The angle combination is calculated in Step ST18 of FIG. 2. The angle combination is selected in Step ST19. Once selected, an angle combination no longer becomes unselected. If there is an unselected angle combination, the processor 110 determines “Yes” in Step ST51 of FIG. 7 and returns to Step ST19 of FIG. 2.

In the second embodiment, the processor 110 selects from the unselected angle combinations in Step ST19.

Conversely, if there is no unselected angle combination, the processor 110 determines “No” in Step ST51 and proceeds to Step ST52.

As described above, by repeating Steps ST19, ST20, ST24, ST27, and ST51 of FIGS. 2 and 7, the processor 110 executes the selected command to which each angle combination calculated in Step ST18 is applied.

In Step ST52 of FIG. 7, the processor 110 selects and determines the optimal angle combination from the plurality of angle combinations, as the angle combination to be used for actual operation. The optimal angle combination is, for example, the one that does not cause interference and has the shortest time to completion. Interference occurs, for example, between the tool 220 and the workpiece 300 or jig. After the processing of Step ST52, the processor 110 proceeds to Step ST34.

Thus, by executing the processing of Step ST52, the processor 110 functions as an example of a determination unit.

The determination information in Step ST34 of the second embodiment indicates the angle combination determined in Step ST52.

According to the numerical control system 1 of the second embodiment, the numerical control device 100 automatically selects the angle combination. The numerical control device 100 of the embodiment automatically determines the angle combination to be used for actual operation. As a result, the numerical control device 100 of the embodiment can reduce the labor of the operator.

The above embodiments can be modified as follows: In the above embodiments, the numerical control device 100 makes the tool 220 perpendicular to the inclined surface 301. However, the numerical control device 100 may use another angle instead of perpendicularity. The other angle is an example of a predetermined angle.

The numerical control device 100 does not necessarily need to include the function to control the industrial machinery 200A. In this case, the numerical control device 100 does not execute the processing illustrated in FIG. 4.

The processor 110 may implement some or all of the processing implemented by the program in the above embodiments by way of the hardware configuration of the circuit.

The program for implementing the processing of the embodiments may be transferred in a state stored on a non-transitory recording medium in the device, for example. However, the device may be transferred without the program stored. The program may be transferred separately and written to the device. The transfer of the program may be implemented, for example, by recording on a removable non-transitory recording medium or by downloading via a network such as the Internet or LAN (local area network).

The embodiments of the present invention described above are presented as examples and do not limit the scope of the present invention. The embodiments of the present invention can be implemented in various forms without departing from the spirit of the present invention.

### EXPLANATION OF REFERENCE NUMERALS

1: numerical control system
100: numerical control device
110: processor
111: program analysis unit
112: position confirmation unit
113: selection setting unit
114: candidate selection unit
115: movement control unit
120: ROM
130: RAM
140: auxiliary storage device
150, 210: input device
160: display device
170: control interface
180: bus
200: industrial machinery
220: tool
230: spindle
231, 232: rotational axis

1. A control device, comprising:
a calculation unit that calculates a plurality of angle combinations for a plurality of rotational axes capable of changing an orientation of a tool such that the tool forms a predetermined angle with a plane;
a selection unit that selects one combination from the plurality of angle combinations calculated by the calculation unit;
a control unit that controls the plurality of rotational axes to change the orientation of the tool oriented in a predetermined orientation such that the tool forms the predetermined angle with the plane, and operates the plurality of rotational axes such that an angle combination for the plurality of rotational axes becomes the combination selected by the selection unit; and
a determination unit that determines one combination to be used for actual operation from the plurality of angle combinations calculated by the calculation unit.

2. The control device according to claim 1, wherein the rotational axes are real rotational axes.

3. The control device according to claim 1, wherein the determination unit determines one combination, based on an operation input.

4. The control device according to claim 1, wherein
the rotational axes are virtual rotational axes, and
an operation of the rotational axes is a simulation by the control unit.

5. The control device according to claim 4, further comprising a display unit that displays a result of the simulation.

6. The control device according to claim 4, wherein
the selection unit selects one combination from the plurality of angle combinations calculated by the calculation unit for each of the plurality of angle combinations calculated by the calculation unit,
the control unit controls the plurality of rotational axes such that the angle combination for the plurality of rotational axes becomes the combination selected by the selection unit for each of the plurality of angle combinations selected by the selection unit, and
the determination unit determines one combination that does not cause interference.

7. The control device according to claim 1, wherein the control unit simultaneously operates the plurality of rotational axes.

8. The control device according to claim 1, wherein
the calculation unit calculates a plurality of first angle combinations such that the tool forms the predetermined angle with a first plane, and calculates a plurality of second angle combinations such that the tool forms the predetermined angle with a second plane,
the control unit controls the plurality of rotational axes to change the orientation of the tool oriented in a first predetermined orientation such that the tool forms the predetermined angle with the first plane, and operates the plurality of rotational axes such that the angle combinations for the plurality of rotational axes become the first angle combinations calculated by the calculation unit for each of the plurality of first angle combinations calculated by the calculation unit, and controls the plurality of rotational axes to change the orientation of the tool oriented in a second predetermined orientation such that the tool forms the predetermined angle with the second plane, and operates the plurality of rotational axes such that the angle combinations for the plurality of rotational axes become the second angle combinations calculated by the calculation unit for each of the plurality of second angle combinations calculated by the calculation unit, and
the determination unit determines one combination to be used for actual operation from the plurality of first angle combinations calculated by the calculation unit, and determines one combination to be used for actual operation from the plurality of second angle combinations calculated by the calculation unit.

9. The control device according to claim 1, wherein, in a case where one combination has already been determined by the determination unit, the control unit does not operate the plurality of rotational axes such that the angle combination for the plurality of rotational axes becomes the combination selected by the selection unit.

10. A control system, comprising:
a control device; and
industrial machinery including a plurality of rotational axes capable of changing an orientation of a tool, wherein
the control device includes:
a calculation unit that calculates a plurality of angle combinations for the plurality of rotational axes such that the tool forms a predetermined angle with a plane;
a selection unit that selects one combination from the plurality of angle combinations calculated by the calculation unit;
a control unit that controls the plurality of rotational axes to change the orientation of the tool oriented in a predetermined orientation such that the tool forms a predetermined angle with the plane, and operates the plurality of rotational axes such that the angle combination for the plurality of rotational axes becomes the combination selected by the selection unit; and
a determination unit that determines one combination to be used for actual operation from the plurality of angle combinations calculated by the calculation unit.

11. A non-transitory computer-readable storage medium storing a program that is executed by a computer that comprises a processor of a control device, the program being executable to cause the computer to perform operations comprising:
calculating a plurality of angle combinations for a plurality of rotational axes capable of changing an orientation of a tool such that the tool forms a predetermined angle with a plane;
selecting one combination from the plurality of angle combinations;
controls controlling the plurality of rotational axes to change the orientation of the tool oriented in a predetermined orientation such that the tool forms the predetermined angle with the plane, and operates the plurality of rotational axes such that the angle combination for the plurality of rotational axes becomes the combination; and
determining one combination to be used for actual operation from the plurality of angle combinations.
